(19) United States
(12) Patent Application Publication
(10) Pub. No.: US 2022/0395112 A1
(43) Pub. Date: Dec. 15, 2022

(54) Smart Refrigerator Assembly

(71) Applicant: Roland Thomlinson, Houston, TX (US)

(72) Inventor: Roland Thomlinson, Houston, TX (US)

(21) Appl. No.: 17/346,723

(22) Filed: Jun. 14, 2021

(51) Int. Cl. A47F 3/04; A47F 3/11; A47F 10/02; G02F 1/163; G05B 15/02

(52) U.S. Cl. CPC A47F 3/0478; A47F 3/0434; A47F 3/0486; A47F 3/11; A47F 10/02; G02F 1/163; G05B 15/02; A47F 2010/025

(57) ABSTRACT

A smart refrigerator assembly includes a refrigerator to facilitate storage of perishable items. Each of a pair of carousels is rotatably integrated into the refrigerator to support perishable food items. Each of a pair of doors is hingedly coupled to the refrigerator for opening and closing the refrigerator. Each of the doors is constructed of an electrochromic material to facilitate the doors to be alternatively opaque or translucent. In this way the doors facilitate contents of the refrigerator to be visible without opening the doors.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to refrigerator device and more particularly pertains to a new refrigerator device for facilitating contents in a refrigerator to be visible without opening the refrigerator. The device includes electrochromic doors which can be actuated into a translucent condition to facilitate an interior of the refrigerator to be visible. Additionally, the device includes a pair of carousels for storing perishable items in the refrigerator.

### (2) Description of Related Art Including Information Disclosed Under 37 CFR 1.97 and 1.98

The prior art relates to refrigerator devices including a refrigerator that has translucent doors for viewing contents of the refrigerator without opening the refrigerator. The prior art discloses a variety of refrigeration units that include various means of wireless communication with a user. Additionally, the prior art discloses a variety of refrigerators that have various means of electronically identifying contents of the refrigerator. In no instance does the prior art disclose a refrigerator with electrochromic doors and which includes a pair of carousels for storing food.

### BRIEF SUMMARY OF THE INVENTION

An embodiment of the disclosure meets the needs presented above by generally comprising a refrigerator to facilitate the perishable items to be stored. A pair of carousels is each of the carousels is rotatably integrated into the refrigerator to support perishable food items. A pair of doors is each of the doors is hingedly coupled to the refrigerator for opening and closing the refrigerator. Moreover, each of the doors is comprised of an electrochromic material thereby facilitating the doors to be alternatively opaque or translucent. In this way the doors facilitate contents of the refrigerator to be visible without opening the doors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a smart refrigerator assembly according to an embodiment of the disclosure.

FIG. 2 is a perspective view of an embodiment of the disclosure showing a pair of doors being opened.

FIG. 3 is a front view of an embodiment of the disclosure.

FIG. 4 is a right side phantom view of an embodiment of the disclosure.

### DETAILED DESCRIPTION OF THE INVENTION

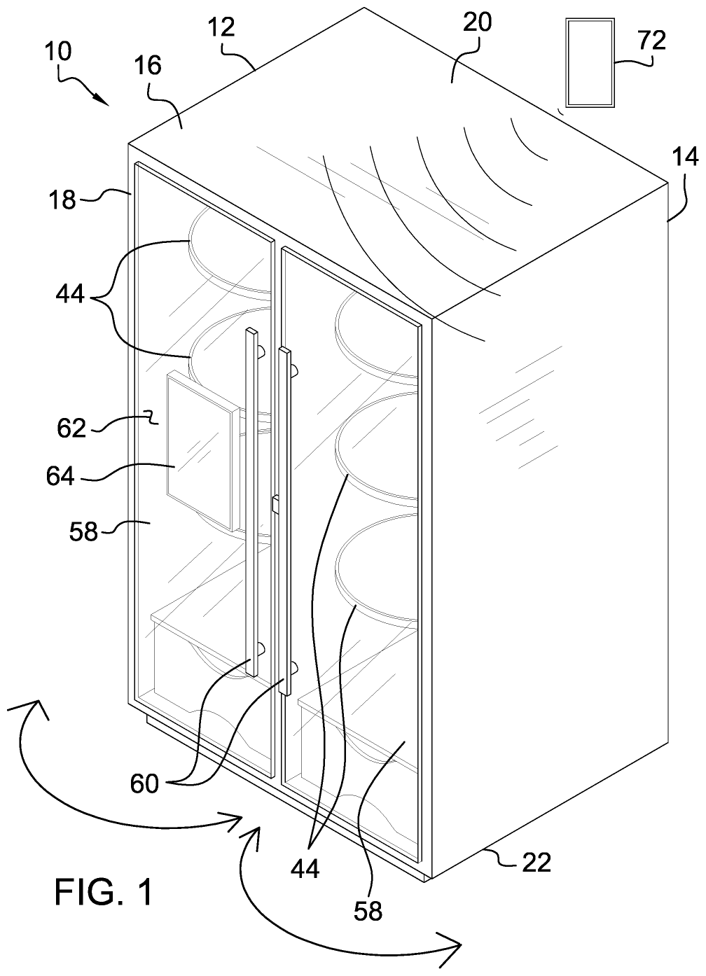

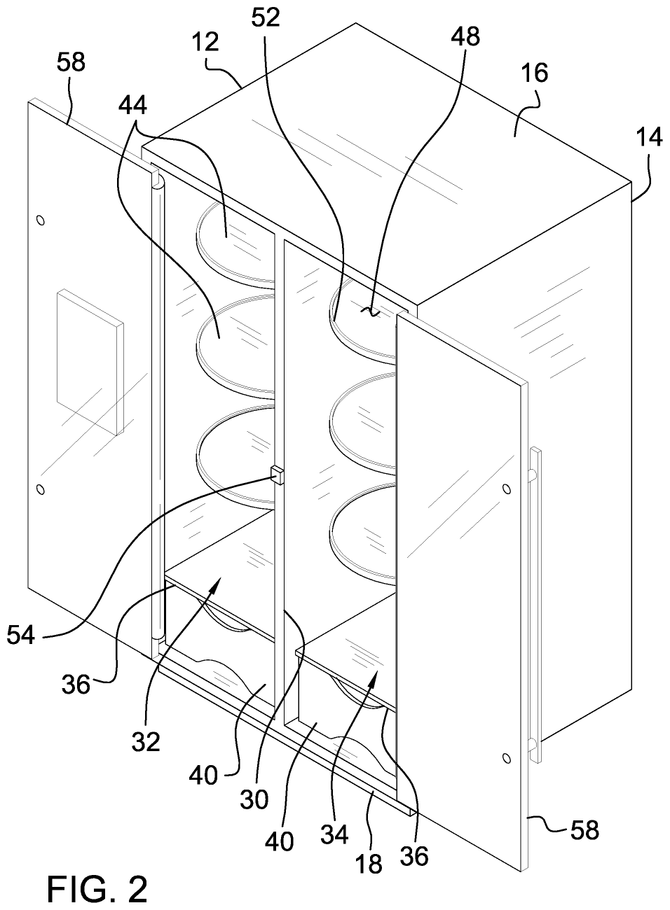

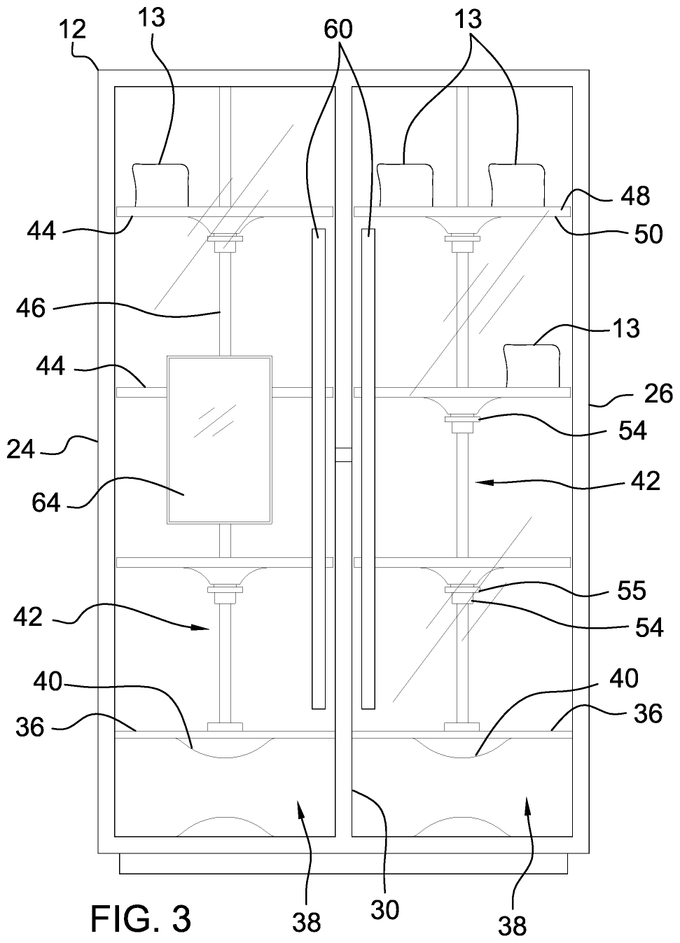

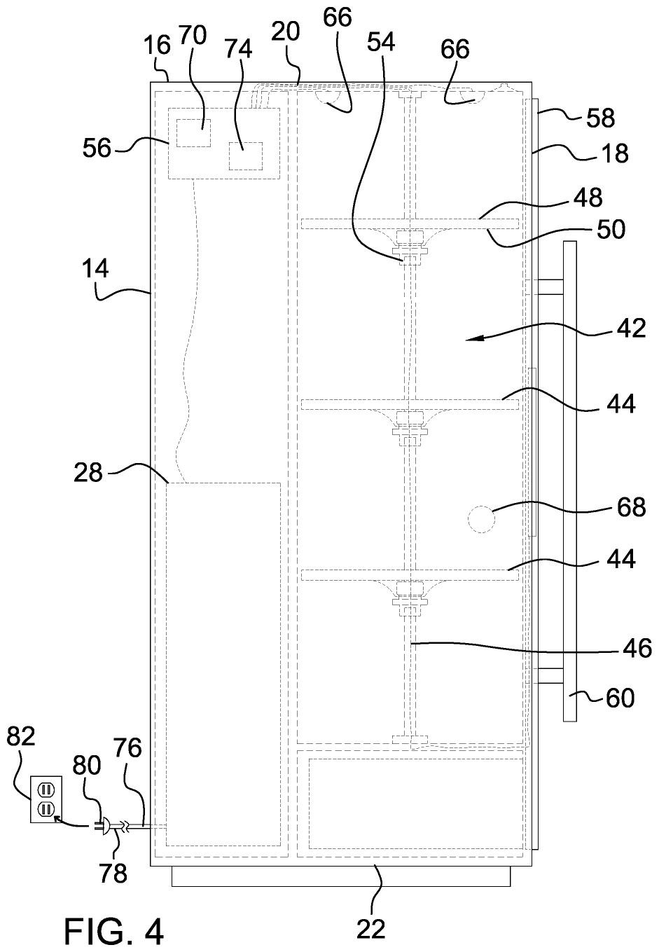

With reference now to the drawings, and in particular to FIGS. 1 through 4 thereof, a new refrigerator device embodying the principles and concepts of an embodiment of the disclosure and generally designated by the reference numeral 10 will be described.

As best illustrated in FIGS. 1 through 4, the smart refrigerator assembly 10 generally comprises a refrigerator 12 that is comprised of a thermally insulating material for storing perishable items 13. The perishable items 13 may include fruits, vegetables, dairy products, meat and any other perishable items 13 that would commonly be found in a kitchen refrigerator 12. The refrigerator 12 has a rear wall 14 and an outer wall 16 extending forwardly therefrom; the outer wall 16 has a front side 18 and the front side 18 is open to access an interior of the refrigerator 12. The outer wall 16 has a top side 20, a bottom side 22, a first lateral side 24 and a second lateral side 26. The refrigerator 12 includes a cooling unit 28 that is positioned within the refrigerator 12. The cooling unit 28 is in thermal communication with the interior of the refrigerator 12 thereby facilitating the cooling unit 28 to maintain the interior at a predetermined temperature. In this way the cooling unit 28 can facilitate the perishable items 13 to be stored for an extended period of time.

The refrigerator 12 has a dividing wall 30 extending between the top side 20 and the bottom side 22 of the outer wall 16 to define a first portion 32 and a second portion 34 of the interior of the refrigerator 12. Additionally, the divider is centrally positioned on the front side 18. A pair of shelves 36 is each positioned within the refrigerator 12 and each of the shelves 36 extends between the dividing wall 30 and a respective one of the first lateral side 24 and the second lateral side 26 of the outer wall 16 of the refrigerator 12. Each of the shelves 36 is spaced from the bottom side 22 of the outer wall 16 to define a drawer space 38 between the shelves 36 and the bottom side 22. A pair of drawers 40 is each slidably positioned within the refrigerator 12 to contain perishable items 13. Each of the drawers 40 is positioned in the drawer space 38 beneath a respective one of the shelves 36.

A pair of carousels 42 is provided and each of the carousels 42 is rotatably integrated into the refrigerator 12. Each of the carousels 42 has a plurality of trays 44 integrated into the carousels 42 and each of the trays 44 support perishable items 13. Moreover, each of the trays 44 is independently rotatable with respect to each other. Each of the carousels 42 includes a pole 46 extending between a respective one of the shelves 36 and the top side 20 of the outer wall 16 of the refrigerator 12. Additionally, the pole 46 associated with each of the carousels 42 is centrally positioned in a respective one of the first portion 32 and the second portion 34 of the interior of the refrigerator 12.

The pole 46 associated with a respective one of the carousels 42 extends through a top surface 48 and a bottom surface 50 of each of the trays 44 associated with the respective carousel 42. Moreover, the trays 44 associated with the respective carousel 42 are spaced apart from each other and are distributed along the pole 46 associated with the respective carousel 42. Each of the trays 44 has a lip 52 extending upwardly from the top surface 48 and the lip 52 on each of the trays 44 extends around a full perimeter of the trays 44 to inhibit the perishable items 13 from sliding off of the trays 44.

Each of the carousels 42 includes a plurality of motors 54 that is each is coupled to the pole 46. Each of the motors 54 engages the bottom surface 50 of a respective one of the trays 44 on the pole 46. Respective ones of the motors 54 rotate the respective tray about the pole 46 when the respective motors 54 are turned on. Each of the motors 54 may comprise an electric motor or the like and each of the motors 54 may include a bearing 55 for supporting the weight of the respective tray 44. A control circuit 56 is provided and the control circuit 56 is integrated into the refrigerator 12. The control circuit 56 is electrically coupled to the cooling unit 28 and the control circuit 56 is electrically coupled to each of the motors 54.

A pair of doors 58 is each hingedly coupled to the refrigerator 12 for opening and closing the refrigerator 12. Each of the doors 58 is positioned on the front side 18 of the outer wall 16 of the refrigerator 12 and each of the doors 58 is aligned with a respective one of the first portion 32 and the second portion 34 of the interior of the refrigerator 12. Each of the doors 58 is comprised of an electrochromic material thereby facilitating the doors 58 to be alternatively opaque or translucent. In this way the doors 58 facilitate contents of the refrigerator 12 to be visible without opening the doors 58. An electronic lock 59 may be integrated into the pair of doors 58 and the electronic lock 59 may be electrically coupled to the control circuit 56. The electronic lock 59 may lock the doors 58 closed at predetermined times of day.

Each of the doors 58 is electrically coupled to the control circuit 56. Additionally, each of the doors 58 has touch sensing capabilities. In this way each of the doors 58 can detect when a user touches the doors 58. Moreover, the control circuit 56 actuates each of the doors 58 into a translucent condition when the doors 58 are touched. In this way the user can see the contents of the refrigerator 12 by simply touching a door, rather than opening the door. Thus, the overall efficiency of the refrigerator 12 is improved by reducing the number of time that the doors 58 will be open. Additionally, each of the doors 58 is in a normally opaque condition. A pair of handles 60 is each coupled to an outer surface 62 of a respective one of the doors 58 for gripping, and each of the handles 60 is vertically oriented on the respective door 58.

A touch screen 64 is coupled to a respective one of the doors 58 such that the touch screen 64 is accessible to a user. The touch screen 64 is in communication with the cooling unit 28 and each of the carousels 42 to control operational parameters of the cooling unit 28 and the carousels 42. Additionally, the touch screen 64 is electrically coupled to the control circuit 56. The touch screen 64 displays icon indicia, menu indicia and word indicia to facilitate controlling operational parameters of the cooling unit 28 and the carousel unit. Each of the motors 54 associated with each of the carousels 42 is independently actuatable with the touch screen 64 to facilitate specific perishable items 13 to be accessible to the user. The touch screen 64 may comprise a liquid crystal display or other type of electronic touch screen.

A decay sensor 66 is integrated into the refrigerator 12 and the decay sensor 66 is in fluid communication with the interior of the refrigerator 12. The decay sensor 66 senses specific organic compounds associated with decaying perishable items 13. In this way the decay sensor 66 can sense when perishable items 13 in the refrigerator 12 have begun to decay. The decay sensor 66 is electrically coupled to the control circuit 56 and the control circuit 56 receives a decay input when the decay sensor 66 senses the specific organic compounds. The decay sensor 66 may be an electronic chemical sensor that is designed to sense various compounds released by the decomposition of organic material.

A label scanner 68 is integrated into the refrigerator 12 to scan labels on the perishable items 13 in the refrigerator 12 for determining an expiration date of the perishable items 13. The label scanner 68 is electrically coupled to the control circuit 56 such that the control circuit 56 receives the expiration dates. The label scanner 68 may be an optical scanner, a laser scanner or other type of electronic scanner that is capable of reading product labels. A transceiver 70 is integrated into the refrigerator 12, the transceiver 70 is electrically coupled to the control circuit 56 and the transceiver 70 is in wireless communication with a personal electronic device 72. The personal electronic device 72 may be a smart phone or the like. The transceiver 70 may comprise a radio frequency transceiver and the transceiver 70 may employ Bluetooth communication protocols.

The transceiver 70 broadcasts a decay alert to the personal electronic device 72 when the control circuit 56 receives the decay input. In this way the transceiver 70 can alert the user that perishable items 13 have begun to decay. The transceiver 70 broadcasts an expiration alert to the personal electronic device 72 when the expiration date of any perishable item has passed. In this way the transceiver 70 can alert the user that a perishable item has expired. The control circuit 56 might include an electronic memory 74 that stores operational software, such as a shopping list compiler to automatically create a shopping list based on expiration dates of the perishable items 13 in the refrigerator 12.

A power cord 76 is coupled to and extends away from the refrigerator 12 and the power cord 76 is electrically coupled to the control circuit 56. The power cord 76 has a distal end 78 with respect to the refrigerator 12 and a male plug 80 is electrically coupled to the distal end 78. The male plug 80 can be plugged into a female electrical outlet 82.

In use, either of the doors 58 is touched to actuate the doors 58 into the translucent condition. In this way the contents of the refrigerator 12 can be viewed without opening the doors 58. Additionally, the touch screen 64 can be manipulated to rotate selected trays 44 to view all of the contents of the refrigerator 12. The personal electronic device 72 receives alerts when decaying food is detected or when an expiration date of food in the refrigerator 12 has passed. In this way the user is notified to remove the decaying or expired food from the refrigerator 12. Additionally, the personal electronic device 72 may receive a shopping list that includes the expired food items to facilitate the user to purchase replacement food items.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A smart refrigerator assembly having electrochromic doors thereby facilitating contents to be visible without opening doors, said assembly comprising:
a refrigerator being comprised of a thermally insulating material wherein said refrigerator is configured to store perishable items, said refrigerator including a cooling unit being positioned within said refrigerator, said cooling unit being in thermal communication with said interior of said refrigerator thereby facilitating said cooling unit to maintain said interior at a predetermined temperature wherein said cooling unit is configured to facilitate the perishable items to be stored;
a pair of drawers, each of said drawers being slidably positioned within said refrigerator wherein each of said drawers is configured to contain perishable items;
a pair of carousels, each of said carousels being rotatably integrated into said refrigerator, each of said carousels having a plurality of trays being integrated into said carousels wherein each of said trays is configured to support perishable food items, each of said trays being independently rotatable with respect to each other; and
a pair of doors, each of said doors being hingedly coupled to said refrigerator for opening and closing said refrigerator, each of said doors being comprised of an electrochromic material thereby facilitating said doors to be alternatively opaque or translucent wherein said doors are configured to facilitate contents of said refrigerator to be visible without opening said doors.

2. The assembly according to claim 1, wherein:
said refrigerator has a rear wall and an outer wall extending forwardly therefrom, said outer wall having a front side, said front side being open to access an interior of said refrigerator, said outer wall having a top side, a bottom side, a first lateral side and a second lateral side, said refrigerator having a dividing wall extending between said top side and said bottom side of said outer wall to define a first portion and a second portion of said interior of said refrigerator, said divider being centrally positioned on said front side;
a pair of shelves, each of said shelves being positioned within said refrigerator, each of said shelves extending between said divider and a respective one of said first lateral side and said second lateral side of said outer wall of said refrigerator, each of said shelves being spaced from said bottom side of said outer wall to define a drawer space between said shelves and said bottom side; and
each of said drawers being positioned in said drawer space beneath a respective one of said shelves.

3. The assembly according to claim 2, wherein each of said carousels includes a pole extending between a respective one of said shelves and said top side of said outer wall of said refrigerator such that each of said poles is centrally positioned in a respective one of said first portion and said second portion of said interior of said refrigerator, said pole associated with a respective one of said carousels extending through a top surface and a bottom surface of each of said trays associated with said respective carousel, said trays associated with said respective carousel being spaced apart from each other and being distributed along said pole associated with said respective carousel, each of said trays having a lip extending upwardly from said top surface, said lip on each of said trays extending around a full perimeter of said trays wherein said lip is configured to inhibit the perishable items from sliding off of said trays.

4. The assembly according to claim 3, further comprising a plurality of motors, each of said motors being coupled to said pole, each of said motors engaging said bottom surface of a respective one of said trays on said pole, respective ones of said motors rotating said respective tray about said pole when said respective motors are turned on.

5. The assembly according to claim 1, further comprising:
a control circuit being integrated into said refrigerator, said control circuit being electrically coupled to said cooling unit, each of said doors being electrically coupled to said control circuit, each of said doors having touch sensing capabilities wherein each of said doors is configured to detect when a user touches said doors, said control circuit actuating each of said doors into a translucent condition when said doors are touched, each of said doors being in a normally opaque condition; and
a touch screen being coupled to a respective one of said doors wherein said touch screen is configured to be accessible to a user, said touch screen being in communication with said cooling unit and each of said carousels to control operational parameters of said cooling unit and said carousels, said touch screen being electrically coupled to said control circuit, said touch screen displaying icon indicia, menu indicia and word indicia to facilitate controlling operational parameters of said cooling unit and said carousel unit, each of said motors associated with each of said carousels being independently actuatable with said touch screen wherein said motors are configured to facilitate specific perishable items to be accessible to the user.

6. The assembly according to claim 5, further comprising a decay sensor being integrated into said refrigerator, said decay sensor being in fluid communication with said interior of said refrigerator, said decay sensor sensing specific organic compounds wherein said decay sensor is configured to sense organic compounds associated with decaying perishable items, said decay sensor being electrically coupled to said control circuit, said control circuit receiving a decay input when said decay sensor senses the specific organic compounds.

7. The assembly according to claim 5, further comprising a label scanner being integrated into said refrigerator wherein said label scanner is configured to scan labels on the perishable items in said refrigerator for determining an expiration date of the perishable items, said label scanner being electrically coupled to said control circuit such that said control circuit receives the expiration dates.

8. The assembly according to claim 5, further comprising:
a decay sensor being integrated into said refrigerator, said decay sensor being in fluid communication with said interior of said refrigerator, said decay sensor sensing specific organic compounds wherein said decay sensor is configured to sense organic compounds associated with decaying perishable items, said decay sensor being electrically coupled to said control circuit, said control circuit receiving a decay input when said decay sensor senses the specific organic compounds;
a label scanner being integrated into said refrigerator wherein said label scanner is configured to scan labels on the perishable items in said refrigerator for determining an expiration date of the perishable items, said label scanner being electrically coupled to said control circuit such that said control circuit receives the expiration dates; and
a transceiver being integrated into said refrigerator, said transceiver being electrically coupled to said control circuit, said transceiver being in wireless communication with a personal electronic device, said transceiver broadcasting a decay alert to the personal electronic device when said control circuit receives said decay input wherein said transceiver is configured to alert the user that perishable items have begun to decay, said transceiver broadcasting an expiration alert to the personal electronic device when the expiration date of any perishable item has passed wherein said transceiver is configured to alert the user that a perishable item has expired.

9. A smart refrigerator assembly having electrochromic doors thereby facilitating contents to be visible without opening doors, said assembly comprising:
a refrigerator being comprised of a thermally insulating material wherein said refrigerator is configured to store perishable items, said refrigerator having a rear wall and an outer wall extending forwardly therefrom, said outer wall having a front side, said front side being open to access an interior of said refrigerator, said outer wall having a top side, a bottom side, a first lateral side and a second lateral side, said refrigerator including a cooling unit being positioned within said refrigerator, said cooling unit being in thermal communication with said interior of said refrigerator thereby facilitating said cooling unit to maintain said interior at a predetermined temperature wherein said cooling unit is configured to facilitate the perishable items to be stored, said refrigerator having a dividing wall extending between said top side and said bottom side of said outer wall to define a first portion and a second portion of said interior of said refrigerator, said divider being centrally positioned on said front side;
a pair of shelves, each of said shelves being positioned within said refrigerator, each of said shelves extending between said divider and a respective one of said first lateral side and said second lateral side of said outer wall of said refrigerator, each of said shelves being spaced from said bottom side of said outer wall to define a drawer space between said shelves and said bottom side;
a pair of drawers, each of said drawers being slidably positioned within said refrigerator wherein each of said drawers is configured to contain perishable items, each of said drawers being positioned in said drawer space beneath a respective one of said shelves;
a pair of carousels, each of said carousels being rotatably integrated into said refrigerator, each of said carousels having a plurality of trays being integrated into said carousels wherein each of said trays is configured to support perishable food items, each of said trays being independently rotatable with respect to each other, each of said carousels including:
a pole extending between a respective one of said shelves and said top side of said outer wall of said refrigerator such that each of said poles is centrally positioned in a respective one of said first portion and said second portion of said interior of said refrigerator, said pole associated with a respective one of said carousels extending through a top surface and a bottom surface of each of said trays associated with said respective carousel, said trays associated with said respective carousel being spaced apart from each other and being distributed along said pole associated with said respective carousel, each of said trays having a lip extending upwardly from said top surface, said lip on each of said trays extending around a full perimeter of said trays wherein said lip is configured to inhibit the perishable items from sliding off of said trays; and
a plurality of motors, each of said motors being coupled to said pole, each of said motors engaging said bottom surface of a respective one of said trays on said pole, respective ones of said motors rotating said respective tray about said pole when said respective motors are turned on;
a control circuit being integrated into said refrigerator, said control circuit being electrically coupled to said cooling unit, said control circuit being electrically coupled to each of said motors;
a pair of doors, each of said doors being hingedly coupled to said refrigerator for opening and closing said refrigerator, each of said doors being positioned on said front side of said outer wall of said refrigerator, each of said doors being aligned with a respective one of said first portion and said second portion of said interior of said refrigerator, each of said doors being comprised of an electrochromic material thereby facilitating said doors to be alternatively opaque or translucent wherein said doors are configured to facilitate contents of said refrigerator to be visible without opening said doors, each of said doors being electrically coupled to said control circuit, each of said doors having touch sensing capabilities wherein each of said doors is configured to detect when a user touches said doors, said control circuit actuating each of said doors into a translucent condition when said doors are touched, each of said doors being in a normally opaque condition;
a pair of handles, each of said handles being coupled to an outer surface of a respective one of said doors wherein each of said handles is configured to be gripped, each of said handles being vertically oriented on said respective door;
a touch screen being coupled to a respective one of said doors wherein said touch screen is configured to be accessible to a user, said touch screen being in communication with said cooling unit and each of said carousels to control operational parameters of said cooling unit and said carousels, said touch screen being electrically coupled to said control circuit, said touch screen displaying icon indicia, menu indicia and word indicia to facilitate controlling operational parameters of said cooling unit and said carousel unit, each of said motors associated with each of said carousels being independently actuatable with said touch screen wherein said motors are configured to facilitate specific perishable items to be accessible to the user;
a decay sensor being integrated into said refrigerator, said decay sensor being in fluid communication with said interior of said refrigerator, said decay sensor sensing specific organic compounds wherein said decay sensor is configured to sense organic compounds associated with decaying perishable items, said decay sensor being electrically coupled to said control circuit, said control circuit receiving a decay input when said decay sensor senses the specific organic compounds;
a label scanner being integrated into said refrigerator wherein said label scanner is configured to scan labels on the perishable items in said refrigerator for determining an expiration date of the perishable items, said label scanner being electrically coupled to said control circuit such that said control circuit receives the expiration dates;
a transceiver being integrated into said refrigerator, said transceiver being electrically coupled to said control circuit, said transceiver being in wireless communication with a personal electronic device, said transceiver broadcasting a decay alert to the personal electronic device when said control circuit receives said decay input wherein said transceiver is configured to alert the user that perishable items have begun to decay, said transceiver broadcasting an expiration alert to the personal electronic device when the expiration date of any perishable item has passed wherein said transceiver is configured to alert the user that a perishable item has expired; and
a power cord being coupled to and extending away from said refrigerator, said power cord being electrically coupled to said control circuit, said power cord having a distal end with respect to said refrigerator, said distal end having a male plug being electrically coupled to said distal end wherein said male plug is configured to be plugged into a female electrical outlet.
